(19) United States
(12) Patent Application Publication
(10) Pub. No.: US 2008/0313468 A1
(43) Pub. Date: Dec. 18, 2008

(54) Information terminal and user domain management method

(75) Inventor: Hisashi Yoshikawa, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/005,489

(22) Filed: Dec. 27, 2007

(30) Foreign Application Priority Data
Jun. 13, 2007 (JP) 2007-156577

(51) Int. Cl. H04L 9/14; H04L 9/32

(52) U.S. Cl. 713/182; 380/45

(57) ABSTRACT

When a user domain is to be segmented or a plurality of user domains are to be grouped, user domain management information before segmentation or grouping is inherited and stored as old-generation user domain management information. In addition, the domain generation of each of user domains after segmentation or grouping is updated to generate a domain key for the new generation. Furthermore, a list of terminals as domain members of the new-generation user domain, a list of rights objects as sharing targets, and a list of rights object excluded from the rights objects as sharing targets are generated. The generated new-generation domain key, the list of domain members, the list of rights objects as sharing targets, and the rights object invalidation list are additionally stored as new-generation user domain management information.

### CROSS-REFERENCE TO RELATED APPLICATIONS

This application is based upon and claims the benefit of priority from prior Japanese Patent Application No. 2007-156577, filed Jun. 13, 2007, the entire contents of which are incorporated herein by reference.

### BACKGROUND OF THE INVENTION

1. Field of the Invention

The present invention relates to an information terminal which can segment or group the rights of content acquired from, for example, a content server while a group, a family, or the like share the rights, and a user domain management method.

2. Description of the Related Art

It has recently become popular to use a delivery service of downloading rich content such as music content from a content server to an information terminal such as a cellular phone or a personal computer. In an information terminal which uses this type of service, a downloaded content is temporarily stored in a memory, and the stored content is read from the memory to be played back in accordance with the playback operation by a user.

Some content is provided with rights information for protecting copyrights and the like. Content of this type is encrypted and stored. It is played back after being decrypted under the conditions defined by rights information. Conditions for playback include, for example, a playback count and a playback period. As an encryption scheme, for example, there is used a scheme of encrypting content with a content key comprising, for example, a random number, encrypting the content key with a key encryption key, and further encrypting the key encryption key with a bind key. As a bind key, for example, the authentication information of an information terminal (device) is used. Using such an encryption scheme makes a device bind content. This makes it possible to allow only the information terminal which has encrypted content to play back the content.

There have recently been proposed various mechanisms of allowing a given person to share the above acquired content rights with another person and partially transferring the rights to another person. For example, there has been proposed a mechanism which includes a server for managing the use of rights to allow terminals to share the rights via the server (see, for example, Jpn. Pat. Appln. KOKAI Publication No. 2005-092851).

A method of providing access to an encrypted content by using one of a plurality of consumer systems has also been proposed (see, for example, Jpn. Pat. Appln. KOKAI Publication No. 2006-050624).

The conventionally proposed sharing schemes, however, have the following problems to be solved. According to Open Mobile Alliance Digital Rights Management Secure Content Exchange (OMA DRM SCE), for example, a user domain is set for each family or group to allow terminals in the user domain to share rights. Assume that rights of content are shared by using a user domain. In this case, even if an environmental change such as the movement of a member occurs, it is necessary to allow the member to keep using the shared content. In addition, when the first group is integrated with the second group, it is necessary to allow a member of the first group to continuously use the content in the second group. However, conventionally proposed sharing schemes have presented no mechanism corresponding to the segmentation or grouping of user domains accompanying an environmental change.

### BRIEF SUMMARY OF THE INVENTION

It is an object of the present invention to provide an information terminal which can implement user domain segmentation or grouping without re-generating any rights object which has already been issued.

In order to achieve the above object, according to a first aspect of the present invention, in an information terminal used in a system in which a plurality of users sharing an encrypted content constitute a user domain, when a segmentation request is issued to the user domain, users constituting user domains after the segmentation and rights objects as sharing targets after the segmentation are determined for each of user domains as the source of segmentation and the segmentation destination. A first user domain key associated with the user domain before segmentation, a list of users constituting the user domain, a list of rights objects which have been sharing targets are continuously stored as first-generation user domain management information in correspondence with each of user domains as the segmentation source and the segmentation destination. A second user domain key is also generated in correspondence with each of the user domains as the segmentation source and the segmentation destination. In addition, a list of users after segmentation and a list of rights objects as sharing targets after segmentation are generated in correspondence with each of the user domains as the segmentation source and the segmentation destination on the basis of the determination result. The generated second user domain key, the list of users after segmentation, and the list of rights objects as sharing targets after segmentation are stored as second-generation user domain management information in correspondence with each of the user domains as the source of segmentation and the segmentation destination.

According to a second aspect of the present invention, in an information terminal used in a system in which there are a plurality of user domains each constituted by a plurality of users sharing an encrypted content, when a grouping request is issued to a plurality of user domains, users constituting a user domain after grouping and rights objects which become sharing targets after grouping are determined. A first user domain key associated with each user domain before grouping, a list of users constituting a user domain, and a list of rights objects as sharing targets are stored as first-generation user domain management information. In addition, a second user domain key is generated in correspondence with the user domain after grouping, a list of users constituting the user domain after grouping, and a list of rights objects which have become sharing targets after grouping are generated. The generated second user domain key, the list of users constituting the user domain after grouping, and the list of rights objects which have become sharing targets after grouping are stored as second-generation user domain management information corresponding to the user domain after grouping.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the arrangement of an information terminal according to an embodiment of the present invention;

FIG. 2 is a view showing an outline of user domain segmentation processing by the information terminal shown in FIG. 1;

FIG. 3 is a chart showing a sequence in a case in which a shared content is played back in a user domain after segmentation;

FIG. 4 is a view showing the format of a domain rights object used in the information terminal shown in FIG. 1;

FIG. 5 is a view showing the format of communication data for domain key delivery used in the information terminal shown in FIG. 1;

FIG. 6 is a view showing the arrangement of user domain generation information managed by the information terminal shown in FIG. 1;

FIG. 7 is a flowchart showing a procedure for user domain segmentation control by the information terminal shown in FIG. 1 and control details;

FIG. 8 is a view showing the user domain generation information of user domain A as a segmentation source generated in the process of segmentation control shown in FIG. 7;

FIG. 9 is a view showing the user domain generation information of user domain B as a segmentation destination generated in the process of segmentation control shown in FIG. 7;

FIG. 10 is a view showing changes in intra-DA/DEA confidential information generated by segmentation control shown in FIG. 7;

FIG. 11 is a flowchart showing a procedure for shared content playback control after user domain segmentation by the information terminal shown in FIG. 1 and control details;

FIG. 12 is a view showing an outline of user domain grouping processing by the information terminal shown in FIG. 1;

FIG. 13 is a flowchart showing a procedure for user domain grouping control by the information terminal shown in FIG. 1 and control details;

FIG. 14 is a view showing intra-DA/DEA confidential information generated by grouping control shown in FIG. 13;

FIG. 15 is a view showing intra-DA/DEA confidential information generated by grouping control shown in FIG. 13; and

FIG. 16 is a flowchart showing a procedure for shared content playback control after user domain grouping by the information terminal shown in FIG. 1 and control details.

### DETAILED DESCRIPTION OF THE INVENTION

An outline of the present invention will be described first.

According to a first aspect of the present invention, when a segmentation request is issued to a user domain, a first user domain key associated with the user domain before segmentation, a list of users constituting the user domain, and a list of rights objects which have been sharing targets are continuously stored as first-generation user domain management information in correspondence with each of the user domains as the segmentation source and the segmentation destination. This technique also generates a second user domain key in correspondence with each of the user domains as the segmentation source and the segmentation destination, and generates a list of users after segmentation in correspondence with each of the user domains as the segmentation source and the segmentation destination, and a list of rights objects which have become sharing targets after segmentation on the basis of the above determination result. The generated second user domain key, the list of users after the segmentation, and the list of rights objects which have become sharing targets after the segmentation are then stored as second-generation user domain management information in correspondence with each of the user domains as the segmentation source and the segmentation destination.

According to the first aspect of the present invention, therefore, when a user domain is segmented, a new-generation user domain key, a list of users, and a list of rights objects as sharing targets are generated for each user domain after segmentation, and are newly stored as second user domain management information while the old-generation first user domain management information which has been used in the user domain before segmentation is continuously stored/held. The user can therefore use both forms of encrypted content shared in both the generations before and after segmentation.

According to a second aspect of the present invention, when a grouping request is issued to a plurality of user domains, a first user domain key associated with each user domain before grouping, a list of users constituting each user domain, and a list of rights objects as sharing targets are stored as first-generation user domain management information. In addition, a second user domain key is generated in correspondence with the user domain after grouping, and a list of users constituting the user domain after grouping and a list of rights objects which have become sharing targets after grouping are generated. The generated second user domain key, the list of users constituting the user domain after grouping, and the list of rights objects as sharing targets after grouping are stored which have become second-generation user domain management information corresponding to the user domain after grouping.

According to the second aspect of the present invention, therefore, when user domains are grouped, a new-generation user domain key, a list of users, and a list of rights objects as sharing targets are generated in correspondence with the user domain after grouping. These pieces of information are then newly stored as second user domain management information while the old-generation first user domain management information which has been used in each user domain before grouping is continuously stored/held. The user can therefore use both forms of encrypted content shared by both generations before and after grouping.

According to the first and second aspects of the present invention, therefore, there can be provided an information terminal which can implement user domain segmentation and grouping without generating again any rights objects which have already been issued and used before segmentation or grouping.

An embodiment of the present invention will be described next.

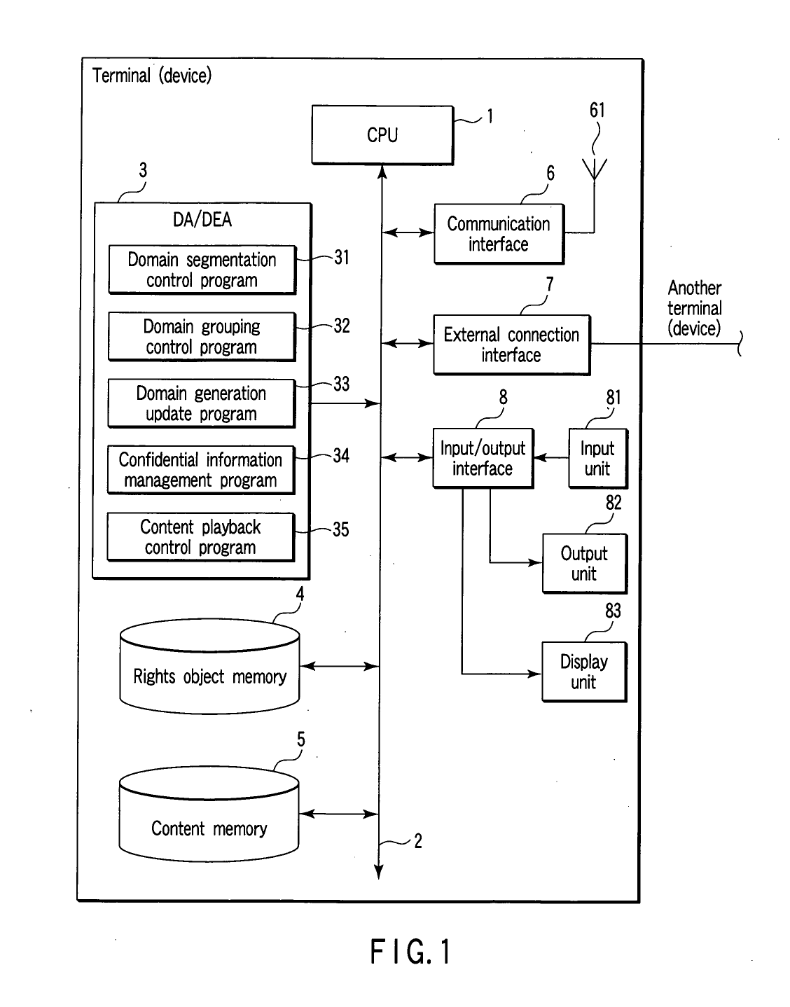

FIG. 1 is a block diagram showing the arrangement of an information terminal according to an embodiment of the present invention.

This information terminal (to be simply referred to as a terminal or device hereinafter) comprises, for example, a portable terminal such as a cellular phone or personal digital assistant (PDA) or a personal computer, and can access a content server (not shown) via a communication network. A desired content is downloaded from the content server and stored in a memory such as a hard disk.

Note that a communication network comprises an Internet Protocol (IP) network typified by the Internet and a plurality of access networks for access to the IP network. As an access network, for example, a wired subscriber network using a digital subscriber line (DSL) or an optical transmission line, a wireless local area network (LAN), or a mobile communication network is used. The terminal can connect to another terminal via a signal cable such as a Universal Serial Bus (USB) cable or the like. Another terminal also comprises a portable terminal or a personal computer.

The terminal includes a central processing unit (CPU) 1. A program memory 3, rights object memory 4, and content memory 5 are connected to the CPU 1 via a bus 2. In addition, a communication interface 6, external connection interface 7, and input/output interface 8 are connected to the CPU 1.

The communication interface 6 is connected to an antenna 61 and performs wireless communication with a base station (not shown). In addition, the communication interface 6 communicates with a content server via the base station to download content. As a communication protocol, for example, Transmission Control Protocol/Internet Protocol (TCP/IP) is used. The external connection interface 7 includes, for example, a USB interface function, and transfers encrypted content to another terminal via a signal cable.

An input unit 81, output unit 82, and display unit 83 are connected to the input/output interface 8. The input unit 81 comprises a plurality of function keys and a key pad, and is used by the user to input commands and the like associated with communication and the playback of content. The output unit 82 comprises a loudspeaker, and outputs an audio signal decoded by an audio decoder provided for the input/output interface 8 as sound. The display unit 83 comprises a liquid crystal display, and displays various kinds of information associated with information necessary for the communicating operation of the terminal and the playback of content.

The program memory 3 comprises a hard disk or a nonvolatile memory such as a ROM. The program memory 3 stores a digital rights management (DRM) agent (not shown) and a domain authority/domain enforcement agent (DA/DEA) as application programs for control according to the present invention.

The DRM agent has a program for managing rights objects RO. Righted content downloaded from the content server comprises content and a rights object RO. An RO management program causes the CPU 1 to execute the processing of managing the rights object RO. The RO management program causes the CPU 1 to perform decryption processing for the rights object RO and decryption processing for the encrypted content when playing back the content.

According to the above description, the content and the rights object RO are downloaded from one content server. In a system including both a content server which manages content and a rights server which manages the rights objects RO, a terminal separately downloads content and the rights object RO. In this system, content downloaded from the content server contains information indicating the location of the rights server. The terminal accesses the rights server on the basis of this information to download the rights object RO.

The DA/DEA is an entity which manages a policy for user domains (domain policy) and comprises a domain segmentation control program 31, domain grouping control program 32, domain generation update program 33, confidential information management program 34, and content playback control program 35 as programs for implementing functions associated with the present invention.

When a user domain segmentation request is input from the self terminal or another terminal, the domain segmentation control program 31 causes the CPU 1 to execute the following control. First of all, the CPU 1 selects the DA/DEA of a user domain as a segmentation destination, and determines, with this DA/DEA, terminals as domain members, content as sharing targets, and domain rights objects for each of the user domains as the segmentation source and the segmentation destination. The CPU 1 causes the domain generation update program 33 to perform domain generation update processing for each of the user domains as the segmentation source and the segmentation destination and causes the confidential information management program 34 to generate user domain management information for each generation.

When a grouping request for a plurality of user domains is input from the self terminal or another terminal, the domain grouping control program 32 causes the CPU 1 to execute the following control. First of all, the CPU 1 performs mutual authentication between the respective user domains as grouping targets, and then determines a user domain as a master after grouping. If the self domain becomes a master, the CPU 1 causes the domain generation update program 33 to perform domain generation update processing and also causes the confidential information management program 34 to generate user domain management information for each generation.

When an instruction to perform domain generation update processing is issued from the domain segmentation control program 31 or the domain grouping control program 32, the domain generation update program 33 causes the CPU 1 to execute the processing of generating a new-generation domain key for each of the user domains as the segmentation source and the segmentation destination or for the user domain after grouping.

In response to an instruction to perform user domain management information generation processing from the domain segmentation control program 31 or the domain grouping control program 32, the confidential information management program 34 causes the CPU 1 to execute the following processing.

That is, user domain management information is changed or generated for each of the user domains as the segmentation source and the segmentation destination or the user domain after grouping. User domain management information is changed or generated for each generation. Of these pieces of information, as indicated by UDI(1G) in FIG. 6, the old-generation information comprises a domain key KD_{—}1G which has been used in the user domain before segmentation or grouping, a list of terminals which have been domain members in the user domain before segmentation or grouping, a list of rights objects which have been sharing targets in the user domain before segmentation or grouping, and a list of rights objects (rights object invalidation list) excluded from rights objects as sharing targets by the above segmentation or grouping.

As indicated by UDI(2G) in FIG. 6, the new-generation information comprises a domain key KD_{—}2G which is newly generated by the domain generation update program 33, a list of devices which become domain members in the second-generation user domain after segmentation or grouping, a list of rights objects as sharing targets in the second-generation user domain, and a list of rights objects excluded from rights objects as sharing targets in the second-generation user domain. The confidential information management program 34 stores the changed or generated first-generation user domain management information UDI(1G) and second-generation user domain management information UDI(2G) as intra-DA/DEA confidential information in the confidential information storage area in the program memory 3.

When a participation request for the user domain is transmitted from a terminal, the content playback control program 35 causes the CPU 1 to execute the following control. First of all, the CPU 1 reads user domain management information corresponding to the requested user domain from the confidential information storage area of the program memory 3 and determines on the basis of the device list contained in the management information whether to permit the participation of the request source terminal. If the CPU 1 determines to permit the participation, the CPU 1 causes the communication interface 6 or the external connection interface 7 to securely transmit domain keys for all the generations and the rights object invalidation list which are contained in the user domain management information to the request source terminal.

The content memory 5 stores content to be shared in the user domain which is acquired from the content server via the communication interface 6 or the input/output interface 8. The rights object memory 4 stores the rights object RO associated with the content stored in the content memory 5. Note that the content memory 5 and rights object memory 4 each comprise a nonvolatile memory which allows writing and reading of data as needed, e.g., a hard disk or a NAND-type flash memory.

The content stored in the content memory 5 and the rights object RO for the user domain stored in the rights object memory 4 each have the following arrangement. FIG. 4 is a view showing the format of the domain rights object RO of these pieces of information.

First of all, the content is encrypted with a content key KCEK and stored in the content memory 5. The above content key is encrypted with a key encryption key. The key encryption key is encrypted with a user domain key KD managed as intra-DA/DEA confidential information together with a verification key. Note that the content key and the key encryption key are generated on the basis of random numbers. Note that the key encryption key may be generated by using information unique to the terminal (e.g., the device number or the telephone number) instead of a random number.

The domain rights object RO comprises the above rights information, the content key encrypted with the key encryption key, the key encryption key encrypted with the user domain key KD, and the inspection key. A message authentication code (MAC) value is added to the domain rights object RO. This MAC value is calculated on the basis of the above respective elements constituting the rights object RO. Adding a MAC value makes it possible to verify whether the rights object RO is tampered, by calculating the MAC value of a portion from which the MAC value of the rights object RO is excluded by using the inspection key, and determining whether the calculated value coincides with the MAC value added to the rights object RO.

Domain segmentation control operation and domain grouping control operation by the information terminal having the above arrangement will be described next.

### (1) Segmentation of User Domain

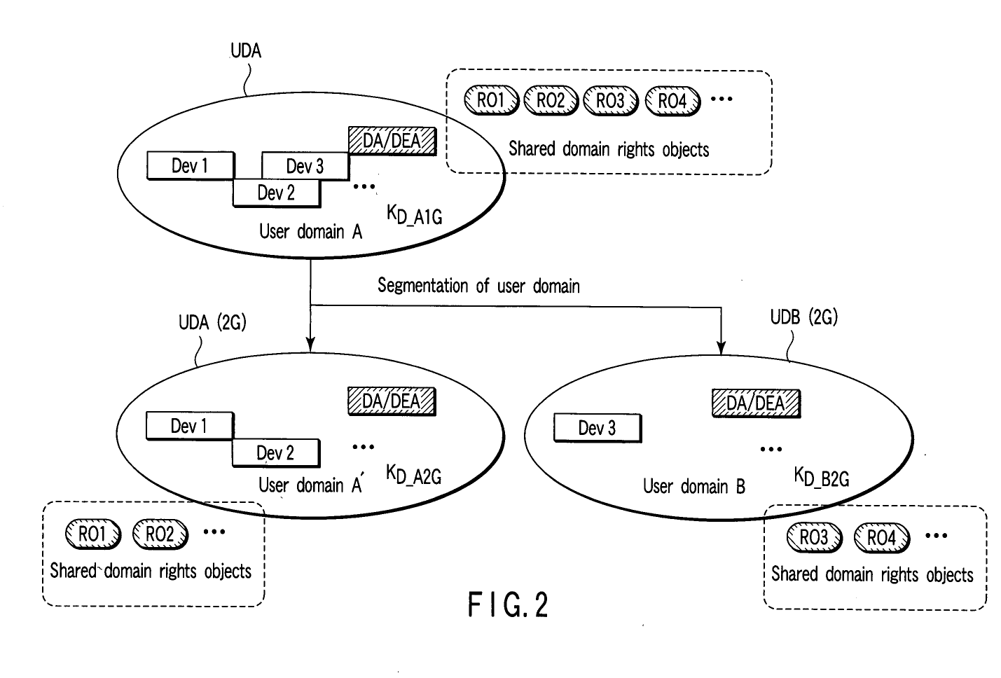

For example, as shown in FIG. 2, the following exemplifies a case in which user domain A (UDA) including terminals Dev1, Dev2, and Dev3 as domain members and sharing domain rights objects RO1, RO2, RO3, and RO4 is segmented into user domain A (UDA′) and user domain B (UDB). User domain A (UDA′) includes terminals Dev1 and Dev2 as domain members and shares domain rights objects RO1 and RO2. User domain B (UDB) includes terminal Dev3 as a domain member and shares domain rights objects RO3 and RO4.

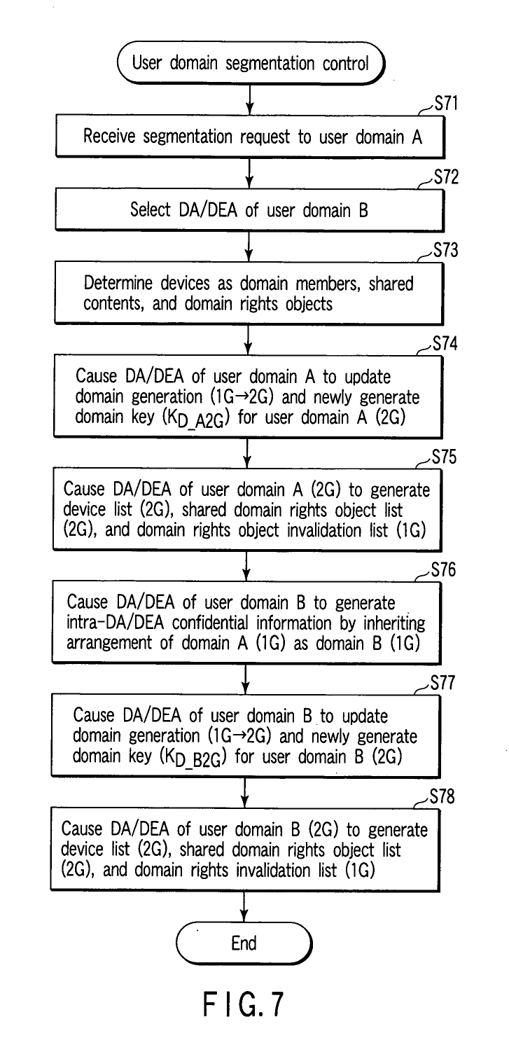

Assume that the DA/DEA of terminal Dev1 manages user domain A. In this case, the DA/DEA of terminal Dev1 executes user domain segmentation control as follows. FIG. 7 is a flowchart showing a control sequence for this operation and control details.

When a user domain segmentation request is input by using the input unit 81 of the self terminal or a user domain segmentation request is sent from another terminal, the DA/DEA of terminal Dev1 accepts this user domain segmentation request in step S71.

The DA/DEA of terminal Dev1 selects a DA/DEA which manages user domain B as the segmentation destination in accordance with the content of the accepted segmentation request in step S72. For example, the DA/DEA selects the DA/DEA of terminal Dev3. Subsequently, the DA/DEA of terminal Dev1 determines terminals as domain members and content/domain rights objects as sharing targets for each of user domain A as the source of segmentation and user domain B as the segmentation destination between itself and the selected DA/DEA of user domain B in step S73. The DA/DEA then changes the user domain management information used before segmentation as follows on the basis of this determination result.

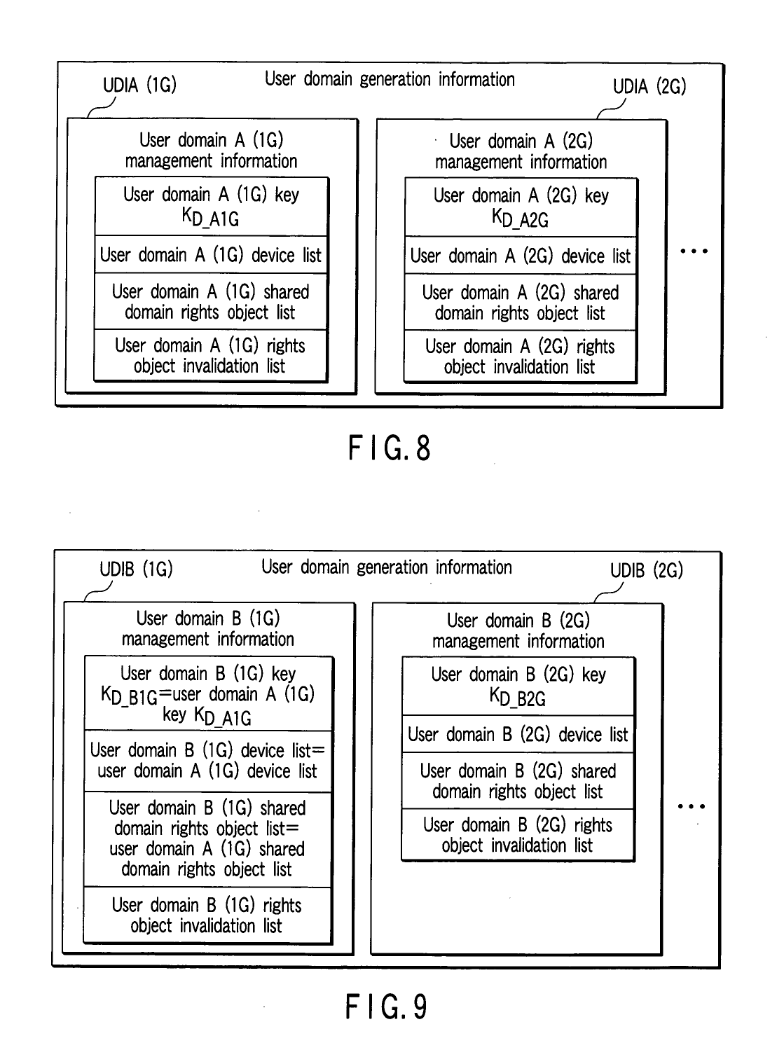

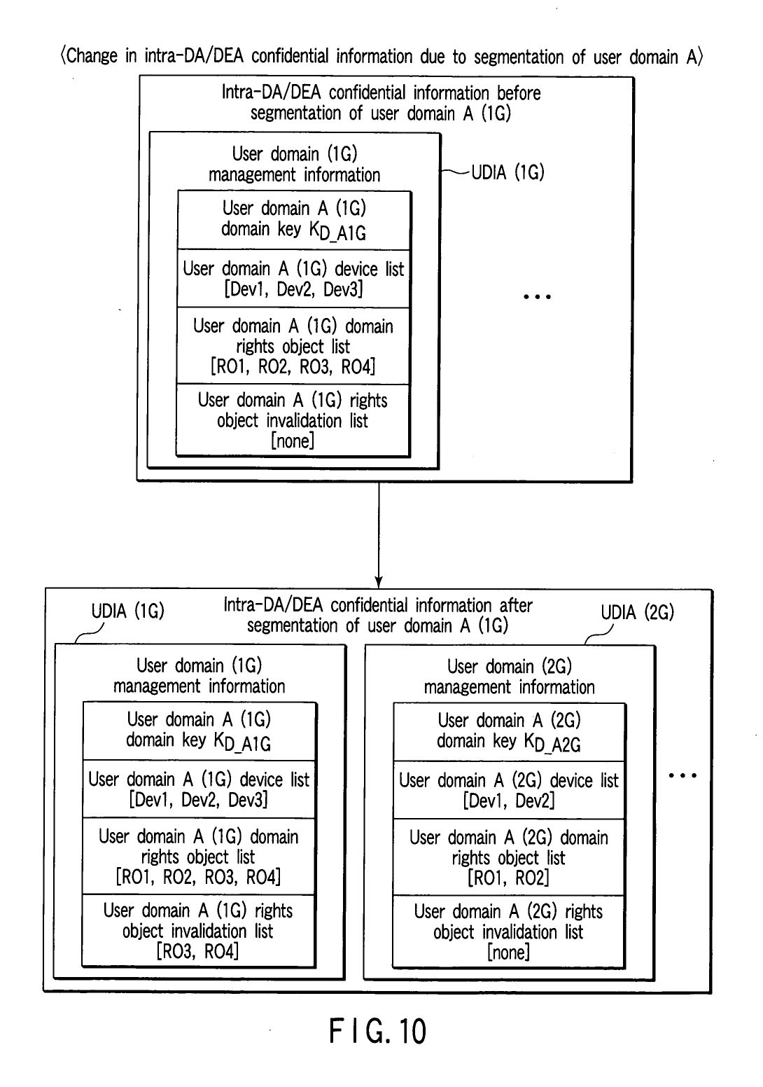

That is, the user domain management information used in user domain A before segmentation comprises a domain key KD_A1G, a device list, a shared domain rights object list, and a rights object invalidation list, as indicated by UDIA(1G) in FIG. 8. More specifically, as shown in FIG. 10, the user domain management information comprises domain key KD_A1G, a device list [Dev1, Dev2, Dev3], a shared domain rights object list [RO1, RO2, RO3, RO4], and a rights object invalidation list [none]. The DA/DEA of terminal Dev1 changes the rights object invalidation list of the user domain management information before segmentation from “none” to [RO3, RO4] as indicated by UDIA(1G)′ in FIG. 10. The user domain management information UDIA(1G)′ after this change is stored as first-generation (old-generation) management information in the confidential information storage area in the DA/DEA.

In step S74, the DA/DEA of terminal Dev1 updates the domain generation of user domain A after segmentation. That is, the DA/DEA of terminal Dev1 generates a domain key KD_A2G used in second-generation user domain A after segmentation. In step S75, the DA/DEA generates a list of terminals as domain members in second-generation user domain A after segmentation, a list of rights objects as sharing targets in second-generation user domain A, and a list of rights objects excluded from rights objects as sharing targets in second-generation user domain A.

More specifically, as shown in FIG. 10, the DA/DEA generates a device list [Dev1, Dev2], a shared domain rights object list [RO1, RO2], and a rights object invalidation list [none]. Generated domain key KD_A2G, the device list [Dev1, Dev2], the shared domain rights object list [RO1, RO2], and the rights object invalidation list [none] are additionally stored as second-generation user domain management information UDIA(2G) of user domain A in the confidential information storage area in the DA/DEA.

On the other hand, the DA/DEA of terminal Dev3 which manages user domain B as the segmentation destination performs processing accompanying segmentation as follows. First of all, in step S76, the DA/DEA acquires the first-generation user domain management information UDIA(1G) from the DA/DEA of terminal Dev1 which manages user domain A as the segmentation source. The DA/DEA then temporarily stores the acquired user domain management information UDIA(1G) as first-generation user domain management information UDIB(1G) of user domain B in the confidential information storage area in the DA/DEA, as shown in FIG. 9.

Subsequently, in step S77, the DA/DEA of terminal Dev3 updates the domain generation of user domain B. That is, the DA/DEA of terminal Dev3 newly generates a domain key KD_B2G used in second-generation user domain B. Subsequently, in step S78, the DA/DEA generates a list of terminals as domain members in second-generation user domain B, a list of rights objects as sharing targets in second-generation user domain B, and a list of rights objects excluded from rights objects as sharing targets in second-generation user domain B.

When, for example, the domain is to be segmented as shown in FIG. 2, the DA/DEA newly generates a device list [Dev3], a shared domain rights object list [RO3, RO4], and a rights object invalidation list [none]. Generated domain key KD_B2G, device list [Dev3], the shared domain rights object list [RO3, RO4], and the rights object invalidation list [none] are stored as second-generation user domain management information UDIB(2G) of user domain B in the confidential information storage area in the DA/DEA.

In addition, the DA/DEA of terminal Dev3 changes the rights object invalidation list [RO3, RO4], of the temporarily stored first-generation user domain management information UDIB(1G) of user domain B, to a first-generation list [RO1, RO2] of user domain B. The DA/DEA then stores the first-generation user domain management information UDIB(1G) after the change of the invalidation list in the confidential information storage area in the DA/DEA.

This completes the processing of segmenting user domain A into user domain A′ and user domain B.

(2) Playback of Content in User Domain after Segmentation

The following exemplifies a case in which a terminal X plays back content by using a domain rights object shared in user domain A′ after segmentation. Assume that terminal X has already acquired the content to be played back and the rights object corresponding to the content from the content server.

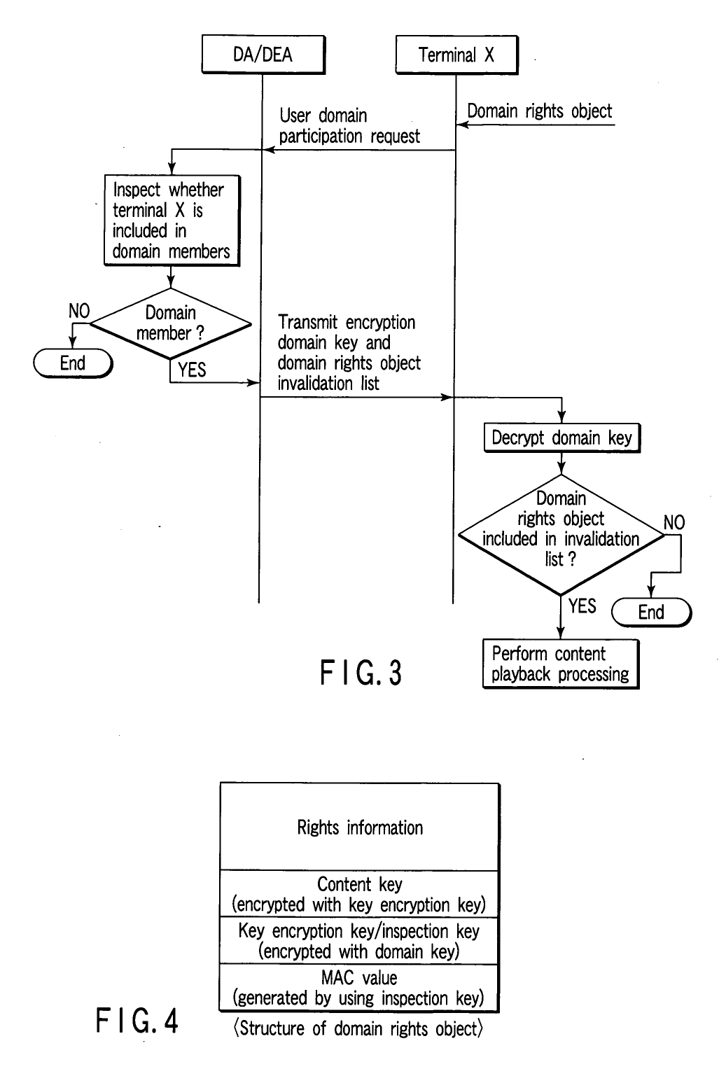

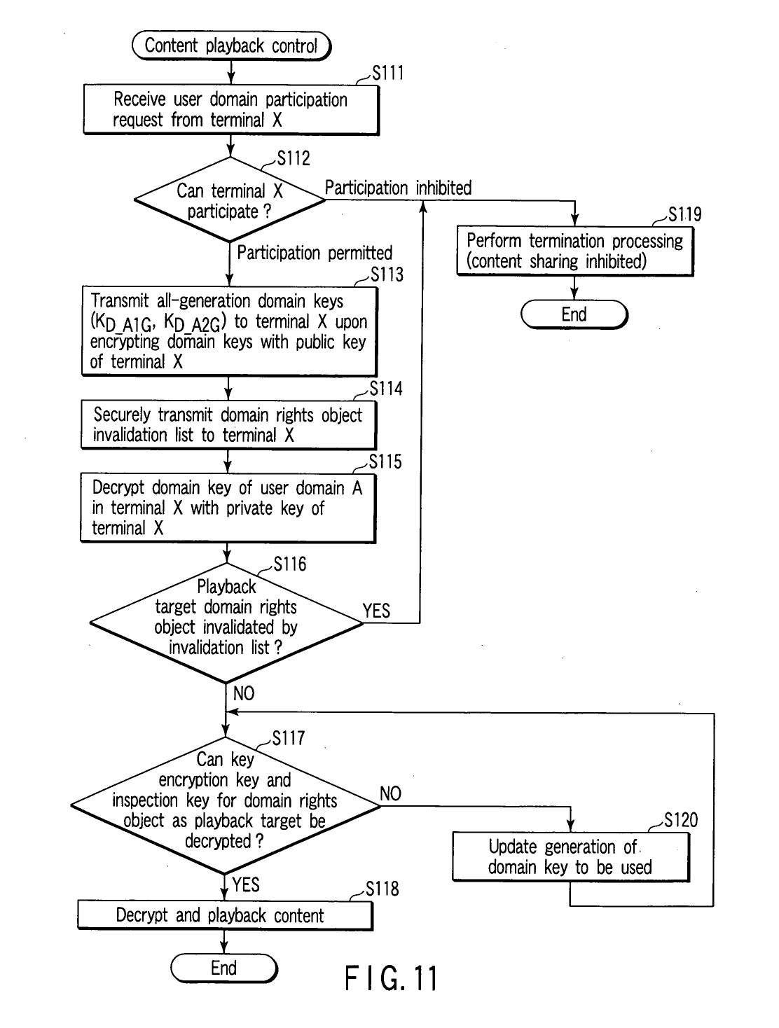

Terminal X transmits a user domain participation request to the DA/DEA of terminal Dev1 belonging to user domain A, as shown in FIG. 3. Upon receiving the above user domain participation request, the DA/DEA of terminal Dev1 executes control necessary for the playback of the content on terminal X in the following manner. FIG. 11 is a flowchart showing a control procedure for this operation and control details.

Upon receiving the user domain participation request in step S111, the DA/DEA of terminal Dev1 reads the second-generation user domain management information UDIA(2G) from its own confidential information storage area, and refers to the domain member list contained in the user domain management information UDIA(2G) to inspect whether terminal X as the request source is contained in the domain member list in step S112. If this inspection result indicates that terminal X as the request source is not contained in the domain member list, the process shifts to step S119 to terminate the processing. At this time, the DA/DEA may return, to terminal X as the request source, a message indicating that the terminal cannot participate in the domain.

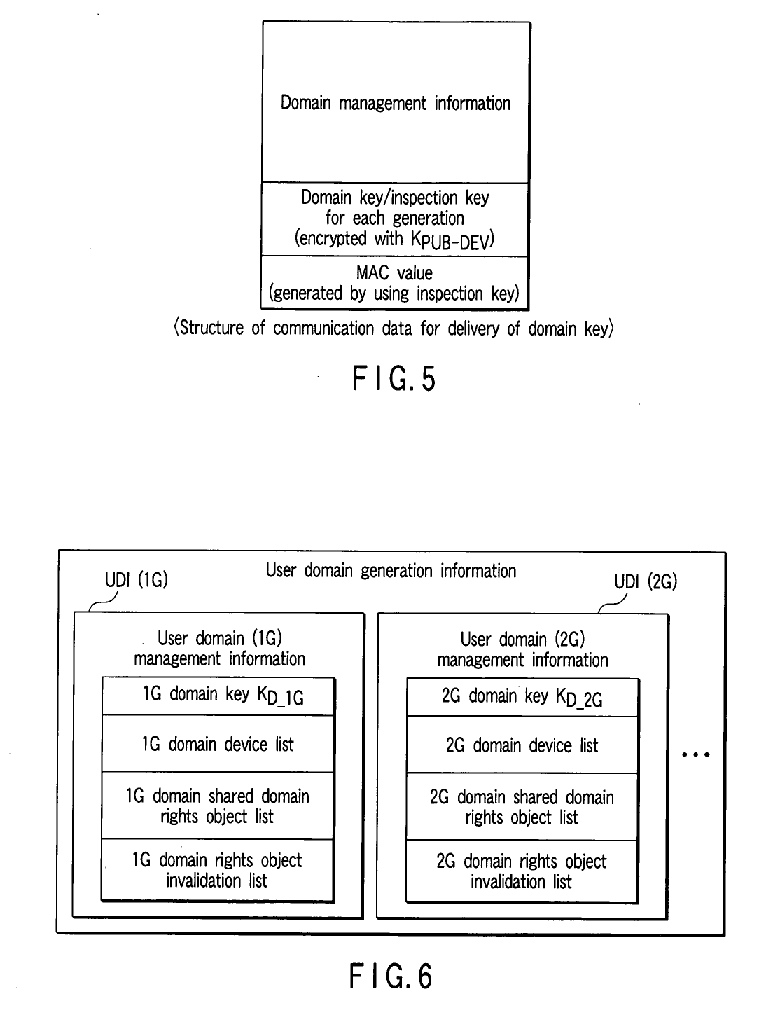

In contrast, assume that the inspection result indicates that terminal X as the request source is contained in the domain list. In this case, the DA/DEA of terminal Dev1 shifts to step S113 to read the pieces of user domain management information UDIA(1G) and UDIA(2G) of all the generations from its own confidential information storage area and encrypt domain keys KD_A1G and KD_A2G contained in these pieces of user domain management information UDIA(1G) and UDIA(2G) by using a public key KPUB_DEV of terminal X, as shown in, for example, FIG. 5. In addition, in step S114, the DA/DEA of terminal Dev1 reads a domain rights object invalidation list from the user domain management information UDIA(2G). The DA/DEA then transmits the encrypted domain keys KD_A1G and KD_A2G and the domain rights object invalidation list from the external connection interface 7 to terminal X as the request source, together with the user domain participation response, as shown in FIG. 3.

Note that when the above domain keys KD_A1G and KD_A2G and the domain rights object invalidation list are to be transmitted, it suffices to encrypt the inspection key as well as domain keys KD_A1G and KD_A2G with the public key, generate a MAC value on the basis of the above inspection key, and transmit the encrypted domain keys KD_A1G and KD_A2G and the encrypted inspection key upon adding the MAC value to them as shown in FIG. 5.

In contrast, first of all, terminal X decrypts domain keys KD_A1G and KD_A2G sent from the DA/DEA of terminal Dev1 by using the private key of terminal X in step S115. Terminal X then refers to the domain rights object invalidation list sent from the DA/DEA of terminal Dev1 to determine in step S116 whether the rights object corresponding to the content to be played back is contained in the invalidation list. If this determination result indicates that the rights object corresponding to the content to be played back is contained in the invalidation list, the process shifts to step S119 to terminate the processing.

If the rights object corresponding to the content to be played back is not contained in the invalidation list, terminal X attempts to decrypt the key encryption key and inspection key of the rights object corresponding to the content to be played back by sequentially using the above decrypted domain keys KD_A1G and KD_A2G in steps S117 and S120. If terminal X has succeeded in decrypting the key encryption key and the inspection key, the terminal decrypts the content key with the decrypted key encryption key and inspection key, decrypts the content by using the decrypted content key, and plays back/outputs the decrypted content.

Participating in user domain A(2G) after segmentation allows terminal X to play back content shared by any generation of user domain A.

### (3) Grouping of User Domains

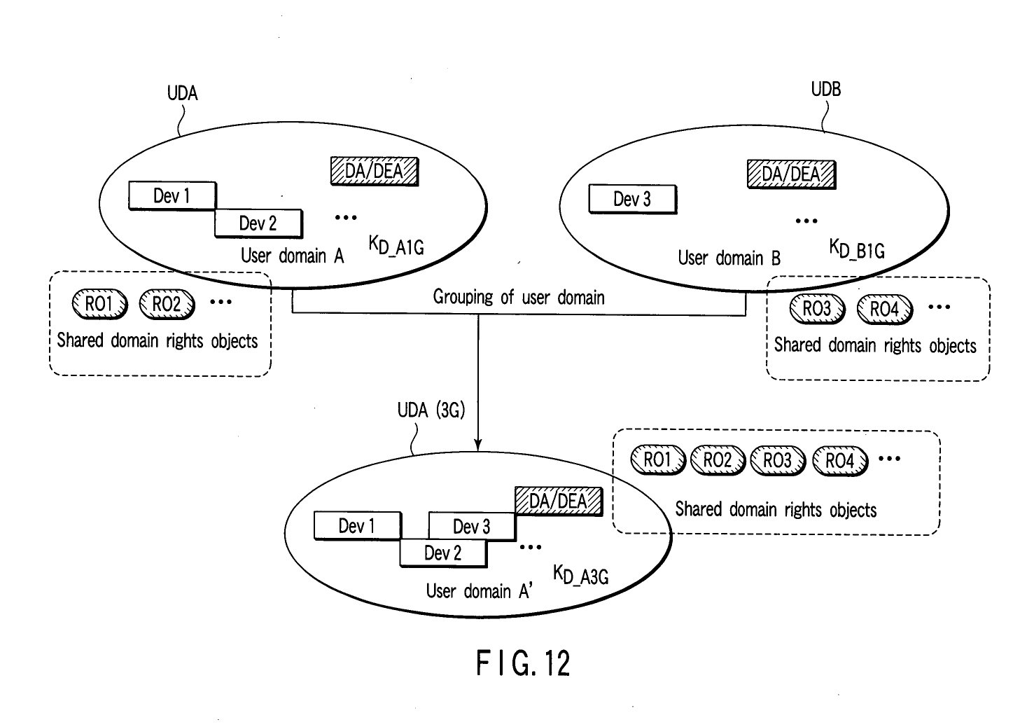

For example, as shown in FIG. 12, the following exemplifies the case of grouping user domain A (UDA) including terminals Dev1 and Dev2 as domain members and sharing domain rights objects RO1 and RO2 and user domain B (UDB) including terminal Dev3 as a domain member and sharing domain rights objects RO3 and RO4.

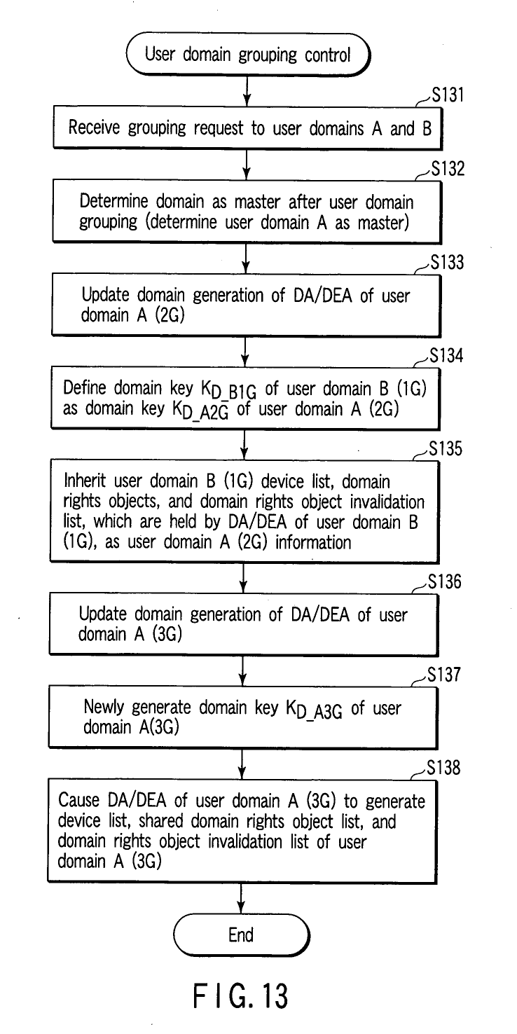

Assume that in the following description, the DA/DEA of terminal Dev1 performs domain management in user domain A, and the DA/DEA of terminal Dev3 performs domain management in user domain B. FIG. 13 is a flowchart showing a grouping control procedure in the DA/DEA of terminal Dev1 and control details.

When a user domain grouping request is input by using the input unit 81 of the self terminal or a user domain grouping request is sent from another terminal, the DA/DEA of terminal Dev1 accepts the user domain grouping request in step S131.

Upon receiving the above user domain grouping request, the DA/DEA of terminal Dev1 performs mutual authentication with the DA/DEA of terminal Dev3 as a grouping target in step S132, and determines a user domain as a surviving domain (master domain) after grouping. Assume that user domain A is a master as shown in FIG. 12.

The DA/DEA of terminal Dev1 which has become a master updates the generation of user domain A from the first generation to the second generation in step S133. At this time, the DA/DEA keeps holding the user domain management information UDIA(1G) used in user domain A before grouping.

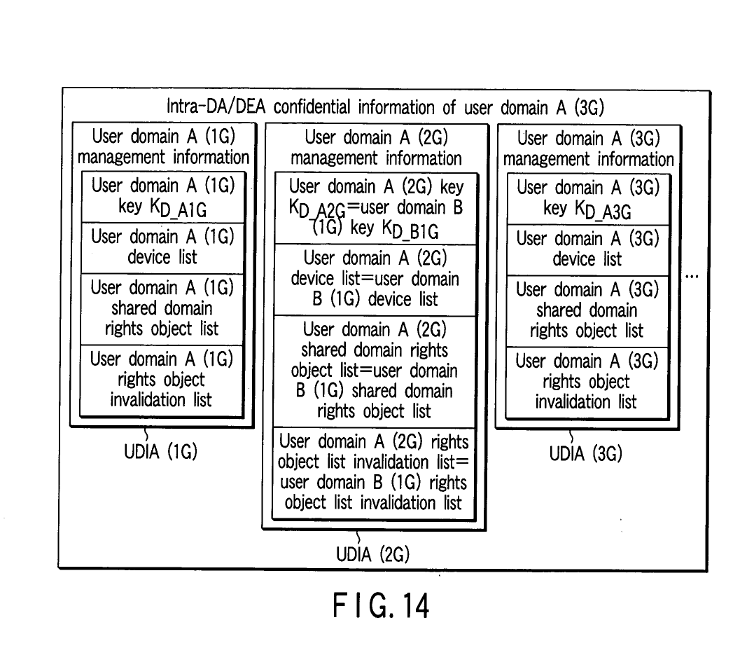

In step S134, the DA/DEA of terminal Dev1 acquires the user domain management information UDIB(1G) used in user domain B from the DA/DEA of terminal Dev3, and defines domain key KD_B1G contained in the acquired user domain management information UDIB(1G) as domain key KD_A2G of second-generation user domain A(2G). In step S135, the DA/DEA inherits the device list, shared domain rights object list, rights object invalidation list contained in the acquired user domain management information UDIB(1G), generates the user domain management information UDIA(2G) of second-generation user domain A(2G) as shown in FIG. 14, and stores the information in the confidential information storage area in the DA/DEA.

The DA/DEA of terminal Dev1 updates the domain generation to the third generation (3G) in step S136. That is, the DA/DEA of terminal Dev1 newly generates a domain key KD_A3G used in third-generation user domain A after grouping in step S137. In step S138, the DA/DEA generates a list of terminals as domain members in third-generation user domain A after grouping, a list of rights objects as sharing targets in third-generation user domain A, and a list of rights objects excluded from the rights objects as sharing targets in third-generation user domain A.

For example, in the case shown in FIG. 12, the DA/DEA generates a device list [Dev1, Dev2, Dev3], a shared domain rights object list [RO1, RO2, RO3, RO4], and a rights object invalidation list [none]. The DA/DEA then additionally stores the device list [Dev1, Dev2, Dev3], the shared domain rights object list [RO1, RO2, RO3, RO4], and the rights object invalidation list [none] as third-generation user domain management information UDIA(3G) in the confidential information storage area in the DA/DEA.

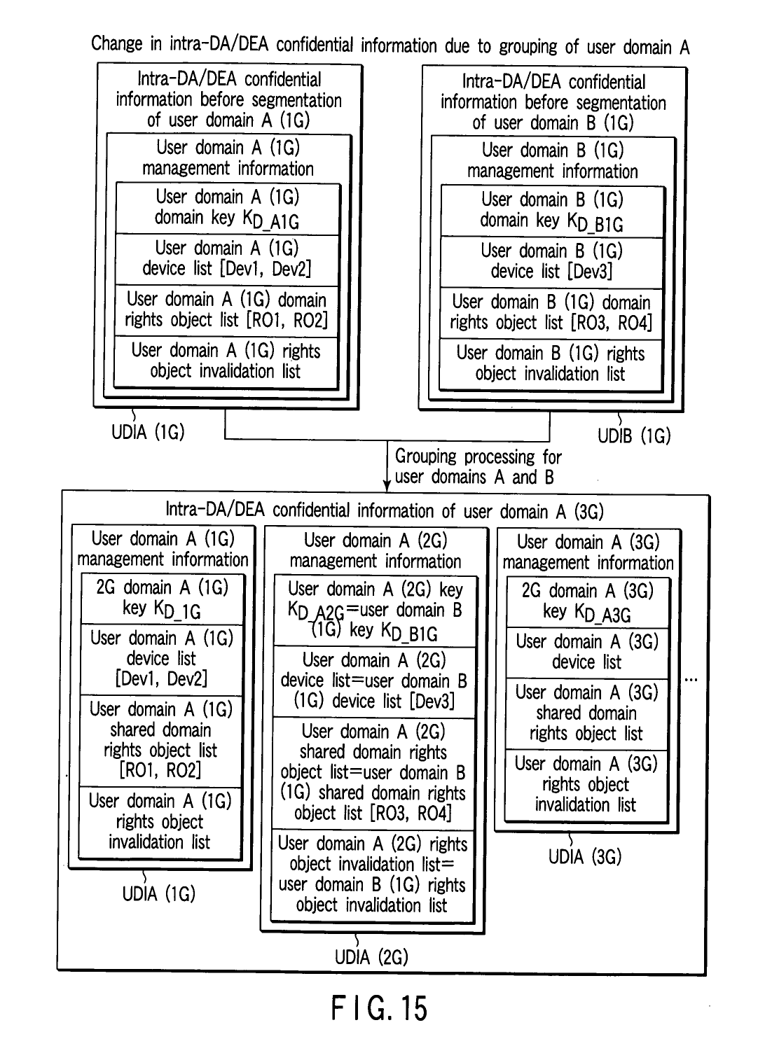

In this manner, as shown in FIG. 15, the DA/DEA of terminal Dev1 after grouping stores the first-generation user domain management information UDIA(1G) used by itself before grouping, the second-generation user domain management information UDIA(2G) inheriting the user domain management information UDIA(1G) used in another user domain B before grouping, and the newly generated third-generation user domain management information UDIA(3G) in the confidential information storage area in the DA/DEA of terminal Dev1 after grouping.

Note that it suffices to terminate the grouping processing after the processing from step S131 to step S135 without performing the processing of updating user domain A to the third generation after grouping in steps S136 to S138.

(4) Playback of Content in User Domain after Grouping

The following exemplifies a case in which terminal X plays back content by using a domain rights object shared in user domain A′ after grouping. Assume that terminal X has already acquired the content to be played back and the rights object corresponding to the content from the content server.

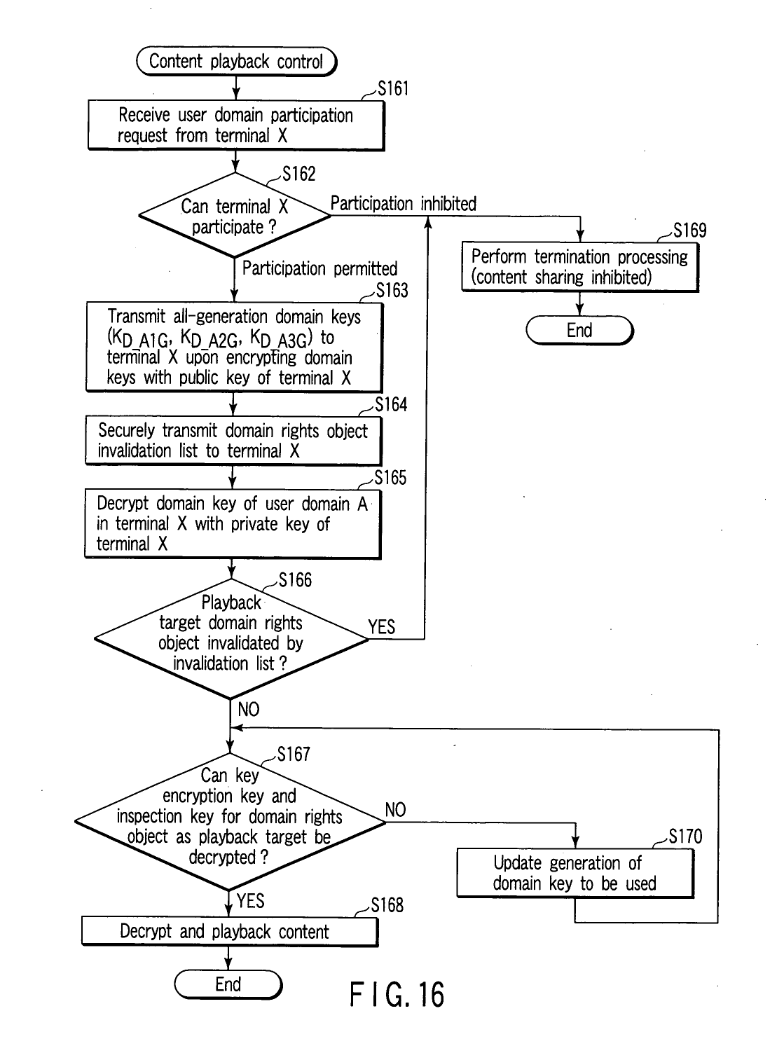

Terminal X transmits a user domain participation request to the DA/DEA of terminal Dev1 belonging to user domain A′ after grouping. Upon receiving the above user domain participation request, the DA/DEA of terminal Dev1 executes control necessary for the playback of the content in terminal X in the following manner. FIG. 16 is a flowchart showing a control procedure for this operation and control details.

Upon receiving the user domain participation request in step S161, the DA/DEA of terminal Dev1 reads the third-generation user domain management information UDIA(3G) from its own confidential information storage area and refers to the domain member list contained in the user domain management information UDIA(3G) to inspect in step S162 whether terminal X as the request source is contained in the domain list. If this inspection result indicates that terminal X as the request source is not contained in the domain member list, the process shifts to step S169 to terminate the processing. In this case, the DA/DEA may return, to terminal X as the request source, a message indicating that the terminal cannot participate in the domain.

In contrast, assume that the inspection result indicates that terminal X as the request source is contained in the domain list. In this case, the DA/DEA of terminal Dev1 shifts to step S113 to read the pieces of user domain management information UDIA(1G), UDIA(2G), and UDIA(3G) of all the generations from its own confidential information storage area and encrypt domain keys KD_A1G, KD_A2G, and KD_A3G contained in these pieces of user domain management information UDIA(1G), UDIA(2G), and UDIA(3G) by using a public key KPUB_DEV of terminal X, as shown in, for example, FIG. 5. In addition, in step S164, the DA/DEA of terminal Dev1 reads a domain rights object invalidation list from the third-generation user domain management information UDIA(3G). The DA/DEA then transmits the encrypted domain keys KD_A1G, KD_A2G, and KD_A3G and the domain rights object invalidation list from the external connection interface 7 to terminal X as the request source, together with the user domain participation response, as shown in FIG. 3.

Note that when the above domain keys KD_A1G, KD_A2G, and KD_A3G and the domain rights object invalidation list are to be transmitted, it suffices to encrypt the inspection key as well as domain keys KD_A1G, KD_A2G, and KD_A3G with the public key, generate a MAC value on the basis of the above inspection key, and transmit the encrypted domain keys KD_A1G, KD_A2G, and KD_A3G and the encrypted inspection key upon adding the MAC value to them, as shown in FIG. 5.

In contrast, first of all, terminal X decrypts domain keys KD_A1G, KD_A2G, and KD_A3G sent from the DA/DEA of terminal Dev1 by using the private key of terminal X in step S165. Terminal X then refers to the domain rights object invalidation list sent from the DA/DEA of terminal Dev1 to determine in step S166 whether the rights object corresponding to the content to be played back is contained in the invalidation list. If this determination result indicates that the rights object corresponding to the content to be played back is contained in the invalidation list, the process shifts to step S169 to terminate the processing.

If the rights object corresponding to the content to be played back is not contained in the invalidation list, terminal X attempts to decrypt the key encryption key and inspection key of the rights object corresponding to the content to be played back by sequentially using the above decrypted domain keys KD_A1G, KD_A2G, and KD_A3G in steps S167 and S170. If terminal X has succeeded in decrypting the key encryption key and the inspection key, the terminal decrypts the content key with the decrypted key encryption key and inspection key, decrypts the content by using the decrypted content key, and plays back/outputs the decrypted content in step S168.

Participating in third-generation user domain A(3G) after grouping allows terminal X to play back content shared by any generation of user domain A.

As described above, in this embodiment, when one user domain A is to be segmented into a plurality of user domains A′ and B or a plurality of user domains A and B are grouped into one user domain A′, the user domain management information before segmentation or grouping is kept stored/held as the old-generation user domain management information. In addition, the embodiment generates a new-generation domain key by updating the domain generation of each of the plurality of user domains after segmentation or one user domain after grouping, and also generates a list of terminals as domain members in the new-generation user domain, a list of rights objects as sharing targets, and a list of rights objects excluded from the rights objects as sharing targets. The embodiment additionally stores the generated new-generation domain key, the list of domain members, the list of rights objects as sharing targets, and the list (invalidation list) of rights objects excluded from the rights objects as sharing targets as new-generation user domain management information in the confidential information storage area in the DA/DEA.

Pieces of user domain management information before and after segmentation and grouping are held as pieces of intra-DA/DEA confidential information of different generations. This allows, when a user domain is segmented or user domains are grouped, domain members to share content without restructuring content which has been shared and domain rights objects.

In addition, the pieces of user domain management information UDIB(1G) and UDIB(1G) used in user domains A and B before grouping are respectively stored as the first-generation user domain management information UDIA(1G) and the second-generation user domain management information UDIA(2G), respectively, after grouping. For this reason, when user domain A′ after the above grouping operation is to be segmented again, it is possible to use the first-generation user domain management information UDIA(1G) and the second-generation user domain management information UDIA(2G) as pieces of user domain management information UDIA(1G) and UDIB(1G) of the respective user domains as the destination of re-segmentation. This makes it possible to easily perform re-segmentation without generating any user domain management information again.

Note that the present invention is not limited to the above embodiment. For example, in the above embodiment, when a terminal is to play back content, the DA/DEA transfers a rights object invalidation list contained in latest-generation user domain management information to the terminal as the domain participation request source. However, the DA/DEA may transfer a rights object list instead of the rights object invalidation list. In this case, the terminal as the participation request source determines on the basis of the transferred rights object list whether the rights object of the content to be played back can be used.

In addition, a terminal including a DA/DEA which manages user domains may control the execution of segmentation or grouping of user domains in accordance with the existing position of the terminal. For example, this control is implemented as follows.

That is, position information indicating an area where the execution of user domain segmentation or grouping is permitted or the identification information of a communication network including the area as a service area is stored as an execution permitted area list in a memory in advance. The existing position of the terminal is detected on the basis of the position information provided from the Global Positioning System (GPS) or a mobile communication base station. It is then determined whether the detected existing position is a position registered in the above stored execution permitted area list. Alternatively, it is determined whether a communication network to which the terminal can connect is a communication network registered in the stored execution permitted area list. If this determination result indicates that the existing position of the terminal is a position registered in the above execution permitted area list or a communication network to which the terminal can connect is a communication network registered in the execution permission area list, the user domain segmentation or grouping request is accepted and corresponding processing is executed. In contrast to this, if it is determined that the existing position of the terminal is not registered in the above execution permitted area list or the communication network to the terminal can connect is not registered in the execution permitted area list, the user domain segmentation request or grouping request is rejected. This arrangement can limit user domain segmentation or grouping processing in accordance with the existing position of a terminal, e.g., a country or area.

In addition, a segmentation or grouping request is stored instead of being rejected. When it is determined afterward that the terminal has moved and its existing position has entered an area registered in the above execution permitted area list or it is determined that the communication network to which the terminal can connect is a communication network registered in the execution permitted area list, it suffices to read the stored segmentation or grouping request and execute it. This arrangement makes it possible to suspend to accept the segmentation or grouping request until the terminal moves to an area where the execution of user domain segmentation or grouping is permitted.

Furthermore, in the above embodiment, old-generation user domain management information used before segmentation or grouping is stored/held after user domain segmentation or grouping. However, it is possible to delete this old-generation user domain management information by the following procedure. First of all, a shared domain rights object encrypted with an old-generation domain key is re-encrypted with a latest-generation domain key. The old-generation user domain management information is then deleted from the confidential information storage area in the DA/DEA.

In addition, it is possible to variously modify and implement the type of information terminal including a DA/DEA and its arrangement, the control procedure for domain segmentation and domain grouping and control details, the types of constituent elements of user domain management information, the encryption scheme used for the transmission of a domain key for user domain management information and the rights object invalidation list to a terminal as a domain participation request source, the number of user domains obtained by segmentation, the number of user domains to be grouped, and the like without departing the spirit and scope of the invention.

Note that the present invention is not limited to the above embodiments, and constituent elements can be variously modified and embodied at the execution stage within the spirit and scope of the invention. Various inventions can be formed by proper combinations of a plurality of constituent elements disclosed in the above embodiments. For example, several constituent elements may be omitted from the all the constituent elements in each embodiment. In addition, constituent elements of the different embodiments may be combined as needed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information terminal used in a system in which a plurality of users sharing an encrypted content constitute a user domain, the terminal comprising:
a module configured to store the encrypted content and a rights object containing rights information corresponding to the encrypted content and encryption key information in correspondence with the user domain, with the encryption key information being encrypted with a first user domain key corresponding to the user domain;
a determination module configured to determine users constituting a user domain after segmentation and a rights object as a sharing target after segmentation for each of user domains as a segmentation source and a segmentation destination in accordance with occurrence of a segmentation request to the user domain;
a module configured to store a first user domain key, a list of users constituting a user domain, and a list of rights objects as sharing targets, which are associated with the user domain before the segmentation, as first-generation user domain management information, in correspondence with each of user domains as the segmentation source and the segmentation destination;
a module configured to generate a second user domain key in correspondence with each of the user domains as the segmentation source and the segmentation destination;
a module configured to generate a list of users after segmentation and a list of rights objects as sharing targets after segmentation on the basis of a determination result obtained by the determination module in correspondence with each of the user domains as the segmentation source and the segmentation destination; and
a module configured to store the generated second user domain key, the list of users after the segmentation, and the list of rights objects as sharing targets after the segmentation as second-generation user domain management information in correspondence with each of the user domains as the segmentation source and the segmentation destination.

2. The terminal according to claim 1, further comprising:
a module configured to generate an invalidation list representing rights objects excluded from rights objects as sharing targets after the segmentation for each of user domains as the segmentation source and the segmentation destination; and
a module configured to store the generated invalidation list with the list being contained in the second-generation user domain management information.

3. The terminal according to claim 1, further comprising:
a module configured to receive a participation request from a user to a user domain after the segmentation;
a module configured to determine, on the basis of a user list contained in the second-generation user domain management information, whether to permit/inhibit participation of a user as a request source, when receiving the participation request;
a module configured to read a first user domain key and a second user domain key from the first-generation user domain management information and the second-generation user domain management information and transmit the first user domain key and the second user domain key to the user as the request source when the determination result indicates that participation of the user as the request source is permitted; and
a module configured to read one of a list of rights objects as sharing targets and an invalidation list of rights objects from the first-generation user domain management information and the second-generation user domain management information and transmit the one of the list of rights object and the invalidation list to the user as the request source.

4. The terminal according to claim 1, further comprising:
a module configured to store an execution permitted area list representing an area in which execution of user domain segmentation processing is permitted;
a module configured to determine whether an existing position of the information terminal corresponds to an area defined by the stored execution permitted area list;
a module configured to accept a user domain segmentation request and execute corresponding processing when it is determined that the existing position of the information terminal corresponds to the area defined by the execution permitted area list; and
a module configured to reject or suspend acceptance of a user domain segmentation request when it is determined that the existing position of the information terminal does not correspond to the area defined by execution permitted area list.

5. An information terminal used in a system in which there are a plurality of user domains each constituted by a plurality of users sharing an encrypted content, the terminal comprising:
a module configured to store the encrypted content and a rights object containing rights information corresponding to the encrypted content and encryption key information in correspondence with each of the plurality of user domains, with the encryption key information being encrypted with a first user domain key corresponding to the user domain;
a determination module configured to determine users constituting a user domain after grouping and a rights object as a sharing target after grouping in accordance with occurrence of a grouping request to the plurality of user domains;
a module configured to inherit and store, as first-generation user domain management information, the first user domain key, a list of users constituting a user domain, and a list of rights objects as sharing targets which are associated with each user domain before the grouping;
a module configured to generate a second user domain key in correspondence with a user domain after the groping;
a module configured to generate a list of users constituting the user domain after the grouping and a list of rights objects as sharing targets after the grouping on the basis of a determination result obtained by the determination module; and
a module configured to store the generated second user domain key, a list of users constituting the user domain after the grouping, and a list of rights objects as sharing targets after the grouping as second-generation user domain management information corresponding to the user domain after the grouping.

6. The terminal according to claim 5, further comprising:
a module configured to receive a participation request from a user to the user domain after the grouping;
a module configured to determine, when the participation request is received, whether to permit participation of the user as a request source, on the basis of a user list contained in the second-generation user domain management information;
a module configured to read a first user domain key and a second user domain key from the first-generation user domain management information and the second-generation user domain management information and transmit the first user domain key and the second user domain key to the user as the request source, when the determination result indicates that the participation of the user as the request source is permitted; and
a module configured to read a list of rights objects as sharing targets from the first-generation user domain management information and the second-generation user domain management information and transmit the list to the user as the request source.

7. The terminal according to claim 5, further comprising:
a module configured to store an execution permitted area list representing an area in which execution of user domain grouping processing is permitted;
a module configured to determine whether an existing position of the information terminal corresponds to the area defined by the stored execution permitted area list;
a module configured to accept a user domain grouping request and execute corresponding processing, when it is determined that the existing position of the information terminal corresponds to the area defined by the execution permitted area list; and
a module configured to reject or suspend acceptance of a user domain grouping request, when it is determined that the existing position of the information terminal does not correspond to the area defined by the execution permitted area list.

8. A user domain management method comprising:
a process of storing the encrypted content and a rights object containing rights information corresponding to the encrypted content and encryption key information in correspondence with the user domain, with the encryption key information being encrypted with a first user domain key corresponding to the user domain;
a process of determining users constituting a user domain after segmentation and a rights object as a sharing target after segmentation for each of user domains as a segmentation source and a segmentation destination in accordance with occurrence of a segmentation request to the user domain;
a process of storing a first user domain key, a list of users constituting a user domain, and a list of rights objects as sharing targets, which are associated with the user domain before the segmentation, as first-generation user domain management information, in correspondence with each of user domains as the segmentation source and the segmentation destination;
a process of generating a second user domain key in correspondence with each of the user domains as the segmentation source and the segmentation destination;
a process of generating a list of users after segmentation and a list of rights objects as sharing targets after segmentation on the basis of a determination result obtained in the process of determining in correspondence with each of the user domains as the segmentation source and the segmentation destination; and
a process of storing the generated second user domain key, the list of users after the segmentation, and the list of rights objects as sharing targets after the segmentation as second-generation user domain management information in correspondence with each of the user domains as the segmentation source and the segmentation destination.

9. The method according to claim 8, further comprising:
a process of generating an invalidation list representing rights objects excluded from rights objects as sharing targets after the segmentation for each of user domains as the segmentation source and the segmentation destination; and
a process of storing the generated invalidation list with the list being contained in the second-generation user domain management information.

10. The method according to claim 8, further comprising:
a process of receiving a participation request from a user to a user domain after the segmentation;
a process of determining, on the basis of a user list contained in the second-generation user domain management information, whether to permit/inhibit participation of a user as a request source, when receiving the participation request;
a process of reading a first user domain key and a second user domain key from the first-generation user domain management information and the second-generation user domain management information and transmitting the first user domain key and the second user domain key to the user as the request source when the determination result indicates that participation of the user as the request source is permitted; and
a process of reading one of a list of rights objects as sharing targets or an invalidation list of rights objects from the first-generation user domain management information and the second-generation user domain management information and transmitting the one of the list of rights objects and the invalidation list to the user as the request source.

11. The method according to claim 8, further comprising:
a process of determining whether an existing position of the information terminal corresponds to an area defined by the stored execution permitted area list;
a process of accepting a user domain segmentation request and executing corresponding processing when it is determined that the existing position of the information terminal corresponds to the area defined by the execution permitted area list; and
a process of rejecting or suspending acceptance of a user domain segmentation request when it is determined that the existing position of the information terminal does not correspond to the area defined by execution permitted area list.

12. A user domain management method comprising:
a process of storing the encrypted content and a rights object containing rights information corresponding to the encrypted content and encryption key information in correspondence with each of the plurality of user domains, with the encryption key information being encrypted with a first user domain key corresponding to the user domain;
a process of determining users constituting a user domain after grouping and a rights object as a sharing target shared after grouping in accordance with occurrence of a grouping request to the plurality of user domains;
a process of inheriting and storing, as first-generation user domain management information, the first user domain key, a list of users constituting a user domain, and a list of rights objects as sharing targets which are associated with each user domain before the grouping;
a process of generating a second user domain key in correspondence with a user domain after the groping;
a process of generating a list of users constituting the user domain after the grouping and a list of rights objects as sharing targets after the grouping on the basis of a determination result obtained by the determination process; and
a process of storing the generated second user domain key, a list of users constituting the user domain after the grouping, and a list of rights objects as sharing targets after the grouping as second-generation user domain management information corresponding to the user domain after the grouping.

13. The method according to claim 12, further comprising:
a process of receiving a participation request from a user to the user domain after the grouping;
a process of determining, when the participation request is received, whether to permit participation of the user as a request source, on the basis of a user list contained in the second-generation user domain management information;
a process of reading a first user domain key and a second user domain key from the first-generation user domain management information and the second-generation user domain management information and transmitting the first user domain key and the second user domain key to the user as the request source, when the determination result indicates that the participation of the user as the request source is permitted; and
a process of reading a list of rights objects as sharing targets from the first-generation user domain management information and the second-generation user domain management information and transmitting the list to the user as the request source.

14. The method according to claim 12, further comprising:
a process of determining whether an existing position of the information terminal corresponds to the area defined by the stored execution permitted area list;
a process of accepting a user domain grouping request and executing corresponding processing, when it is determined that the existing position of the information terminal corresponds to the area defined by the execution permitted area list; and
a process of rejecting or suspending acceptance of a user domain grouping request, when it is determined that the existing position of the information terminal does not correspond to the area defined by the execution permitted area list.
